(19) United States
(12) Patent Application Publication
(10) Pub. No.: US 2011/0232685 A1
(43) Pub. Date: Sep. 29, 2011

(54) APPARATUS AND METHOD FOR REMOVING GUM DEPOSITS, ADHESIVE SUBSTANCES, PAINT AND THE LIKE FROM SURFACES

(76) Inventors: Robert Paffrath, Montreal (CA); Robert Houston, Montreal (CA)

(21) Appl. No.: 13/122,289

(22) PCT Filed: Oct. 1, 2009
(86) PCT No.: PCT/CA2009/001388

§ 371 Date: Jun. 8, 2011

Related U.S. Application Data
(60) Provisional application No. 61/136,761, filed on Oct. 1, 2008.
(60) Provisional application No. 61/202,999, filed on Apr. 27, 2009.

(51) Int. Cl. B08B 3/02

(52) U.S. Cl. 134/18; 134/172

(57) ABSTRACT

An apparatus for removing an adhesive substance such as gum, paint, and the like from a surface is provided. The apparatus includes at least two reservoirs, one reservoir contains water so as to provide steam and another reservoir contains a cleaning agent. A common conduit is in fluid communication with the first and second reservoirs and comprising an outlet. A controller modulates the dispensing of steam and cleaning agent. Applying an effective mixture of steam and cleaning agent onto the surface area having this adhesive substance causes the removal thereof.

### FIELD OF THE INVENTION

The present invention relates to an apparatus and method for cleaning a surface. More particularly, but not exclusively, the present invention relates to an apparatus and method for removing gum deposits, adhesive substances, paint and the like from surfaces.

### BACKGROUND OF THE INVENTION

When chewing gum is improperly disposed such as on a sidewalk, floor, carpeting, or like surface area, it can create a nuisance as well as environmental problems. As is known, typical chewing gum, due to its formulation has adhesive-like characteristics and as such can stick to surfaces to which it is placed after being chewed and discarded. As the gum deposit residue ages, it becomes hard and brittle making it difficult to peel away from the surface to which it is attached. This problem is common in areas such as parks, shopping centers, college campuses, offices, and other public areas when chewed gum deposits can be found on sidewalks, walls and the surfaces of other structures.

Since gum removal is difficult to achieve, known processes often result in marks on the surface or take too long to perform thus raising labor costs considerably. Furthermore, various household remedies remain ineffective.

Improvements to these conventional methods included using steam alone or with known chemicals to further assist the cleaning process. Usually, these apparatuses include a main container with a hose and nozzle. When the chemical is introduced with the steam flow, the steam stops, the chemical continues flow out of the nozzle as long as the operator is pressing the chemical button. Once the operator stops pressing the chemical button the steam resumes. The above system is therefore time consuming and ineffective.

Improvements to the foregoing include an apparatus having a tank that is filled with water and a solvent which can also be dissolved in the water. A heating element heats the water and a space is kept between the water and the top of the tank in order to allow for the production of steam. The tank includes a bottom outlet for water with dissolved solvent and a top outlet for steam. These outlets are controlled by respective valves. The steam and water meet at a common junction where both steam and water can be brought together in order to move through a hose towards a nozzle having a brush and from there be applied to an adhesive substance (such as gum). Therefore, the same tank acts as a reservoir for both the water and the solvent.

The foregoing apparatus presents numerous drawbacks some of which will be enumerated herein. The boiling point of the solvent has to be superior to that of water since solvent will be boiled and lost into the steam. If the boiling point of water is less than that of the solvent, water will be lost faster than solvent and the concentration of solvent will increase thus providing a non-constant mixture. This system only works with miscible solvent systems which can mix with water, therefore it is limited to one type of solvent since non-miscible solvents will stay on top of the water and not flow out of the bottom outlet. Hence, pure solvent cannot be used in this system only diluted solvent. The solvent within the water that meets the steam at the common junction is pre-heated and as such, the temperature of the solvent will not be easy to control since the water/solvent mixture flowing out of the bottom outlet is also hot. The tank requires a top space for the creation of steam above the water thereby requiring a large apparatus.

Other than gum deposits many municipalities suffer from vandalism such as spay paint or general littering resulting in a variety of adhesive substances adhering to various public surfaces. Like chewing gum, removing paint and other adhesive substances from public areas or private buildings is time consuming and costly and improvements are sought.

### OBJECTS OF THE INVENTION

An object of the present invention is to provide an apparatus for cleaning a surface.

An object of the present invention is to provide a method for cleaning a surface.

An object of the present invention is to provide an apparatus for removing an adhesive substance, including without limitation gum deposits or paint, from a surface.

An object of the present invention is to provide a method for removing an adhesive substance, including without limitation gum deposits or paint, from a surface.

### SUMMARY OF THE INVENTION

In accordance with an aspect of the present invention, there is provided an apparatus for removing an adhesive substance from a surface, the apparatus comprising:

a first reservoir for containing water so as to provide steam;

a second reservoir for containing a cleaning agent;

a common conduit in fluid communication with the first and second reservoirs and comprising an outlet;

a controller for modulating the steam and cleaning agent that flows into the common conduit thereby selectively providing a mixture thereof for being simultaneously dispensed from said outlet;

wherein applying an effective mixture of the steam and cleaning agent onto the surface removes the adhesive substance therefrom.

A method of removing an adhesive substance from a surface, the method comprising:

providing a reservoir containing water;

heating the water so as to produce steam;

providing a reservoir containing a cleaning agent;

providing for the cleaning agent and the steam to flow into a common conduit having an outlet;

selectively modulating the amount of steam and cleaning agent simultaneously flowing into the common conduit so as to provide an effective mixture; and

applying the effective mixture on the surface via the outlet so as to remove the adhesive substance therefom.

In accordance with an aspect of the present invention, there is provided an apparatus comprising two separate reservoirs, a first reservoir for water so as to produce steam and a second reservoir for a cleaning agent and means for independently controlling the flow of steam and cleaning agent therefrom into a common conduit so as to provide a simultaneous application on a surface;.

In accordance with an aspect of the present invention, there is provided a method of providing a mixture of steam and a cleaning agent onto a surface for the removal of gum and/or paint and/or another adhesive substance wherein the amount of steam and cleaning agent can be independently balanced or controlled.

Other objects, advantages and features of the present invention will become more apparent upon reading of the following non-restrictive description of non-limiting illustrative embodiments thereof, given by way of example only with reference to the accompanying drawings.

### BRIEF DESCRIPTION OF THE DRAWINGS

In the appended drawings, where like reference numerals denote like elements throughout and in where:

FIG. 1 is perspective view of the present apparatus in accordance with a non-limiting illustrative embodiment of the present invention;

FIG. 2 is a top plan of the present apparatus having its cover removed and revealing the contents therein; and

FIG. 3 is a top plan view of the switch panel on the lance of the apparatus of FIG. 1; and

FIG. 4 is a schematic view of an apparatus for removing an adhesive substance from a surface in accordance with an non-limiting illustrative embodiment of the present invention.

### DETAILED DESCRIPTION OF ILLUSTRATIVE EMBODIMENTS

Generally stated and in accordance with an embodiment of the invention, there is provided an apparatus that includes a first reservoir for containing water, so as to provide steam, and a second reservoir for containing a cleaning agent, such as an adhesive-substance removing chemical, solvent, detergent or other like cleaning agent. A common conduit is in fluid communication with the first and second reservoirs and has an opposite free end with an outlet. This common conduit can be a hose for example allowing the steam and the cleaning agent to simultaneously exit through a nozzle at the free end thereof and then onto the substance that is to be removed. Each of the reservoirs has a shorter conduit leading to the hose. Valves can be mounted on the shorter conduits to control the flow of steam and/or the cleaning agent. A controller balances the amount of steam and/or cleaning agent that flows into the hose in order to provide an effective mixture. The hose can also include a lance for manual operation. The first and second reservoirs are mounted to a trolley. In an embodiment of the present invention, there is provided a method for removing an adhesive substance from a surface. The method includes simultaneously applying steam and a cleaning agent onto the surface that is to be cleaned. More particularly, the method includes balancing between the amount of steam and of the cleaning agent so as to provide an effective mixture.

With reference to the appended drawings, illustrative embodiments of the present invention will be described herein so as exemplify the invention and by no means limit the scope thereof.

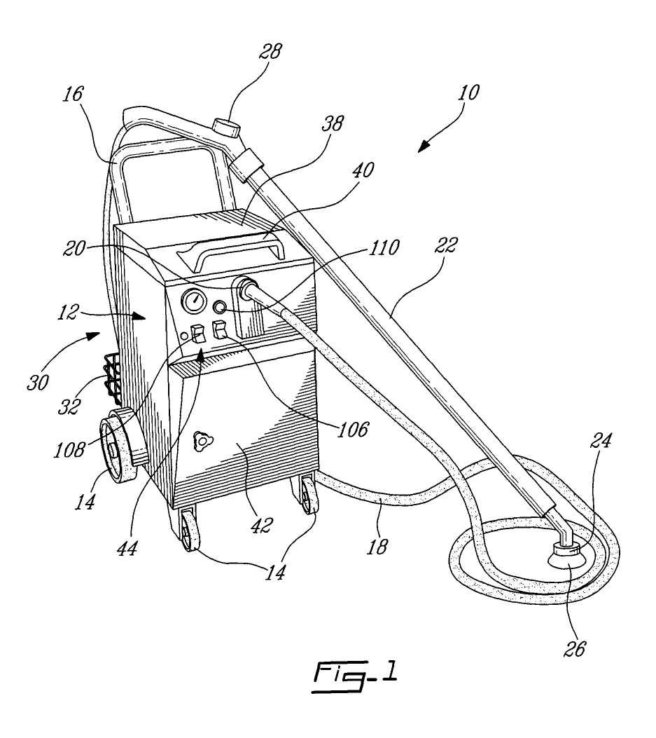

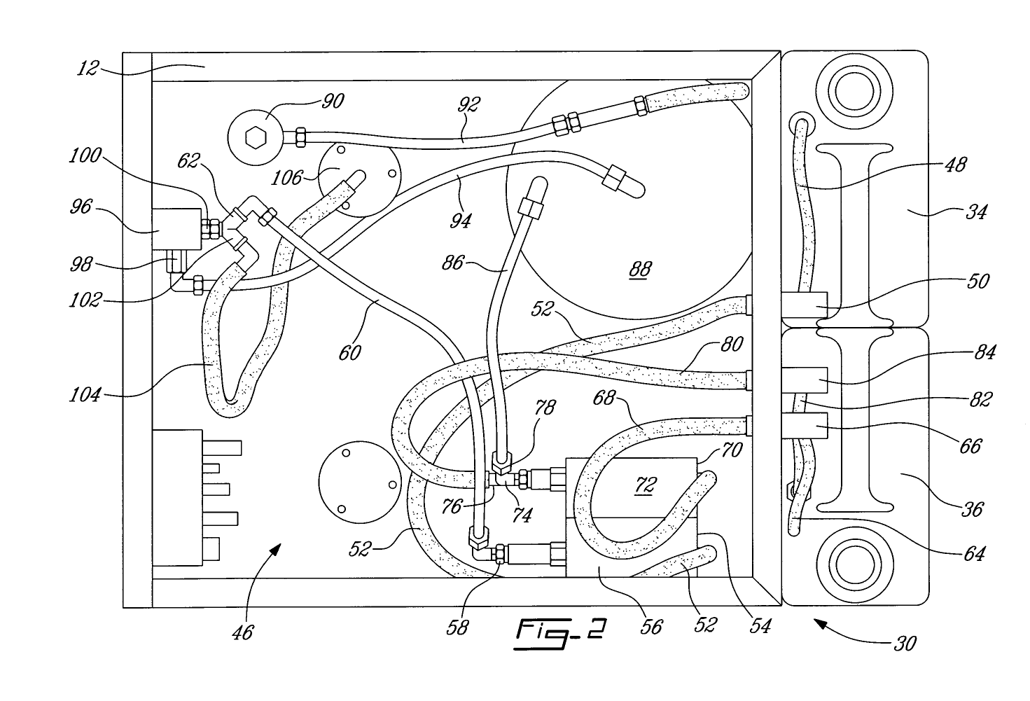

FIG. 1 shows an apparatus 10 having a main body 12 with rollers 14 and a handlebar 16. A conduit such as hose 18 is mounted to an outlet 20 of the main body 12. A handling lance 22 is mounted to the hose 18 and includes a nozzle 24 with a brush 26 at its free end. The lance 22 includes a controller such as switch panel 28. The main body 12 acts as a trolley and can be pushed to roll via the handlebar 16. The rear side 30 of the main body 12 includes a support 32 for carrying a first reservoir (see FIG. 2) such as bottle 36 for containing water and a second reservoir such as bottle 24 for containing a cleaning agent. Furthermore, the main body 12 includes a top cover 38 with a handle 40 as well as a front door 42 thereby allowing access to the internal components thereof.

As is known in the art, a controller such as a control panel 44 provides for operating the apparatus 10. In the present example, the controller comprises the switch panel 28 and the control panel 44.

FIG. 2 shows the inside 46 of the main body 12 when the top cover 38 has been removed.

An external conduit 48 is in fluid communication with the cleaning agent bottle 34 and is mounted, via a connector 50 protruding from the rear side 30 of main body 12, to an internal conduit 52 which leads to the rear side 54 of a cleaning agent pump 56. The pump 56 includes an outlet 58 which is in fluid communication with a second internal conduit 60 that leads to a v-shaped junction 62.

An external in-feed conduit 64 is in fluid communication with the water bottle 36 and is mounted, via a connector 66 protruding from the rear side 30 of the main body 12, to an internal in-feed conduit 68 which leads to the rear side 70 of a water pump 72. The pump 72 includes a bifurcated de-airing device 74 having two outlets 76 and 78. Outlet 76 leads to a return conduit 80, which is in fluid communication with an external return conduit 82, via a connector 84. The external return conduit 82 leads to the water bottle 36. Outlet 78 is in fluid communication with conduit 86 which leads to a steamer 88. The steamer 88 is connected to a pressure regulator 90, via a conduit 92, for activating the heating element (not shown but well known in the art) within the steamer 88. A steam conduit 94 is in fluid communication at one end thereof with the steamer 88 and leads at the other end thereof to a solenoid valve 96 via inlet 98. The solenoid valve 96 has an outlet 100 connected to the v-shaped junction 62.

The v-shaped junction 62 includes an outlet 102 in fluid communication with steam and agent mixture conduit 104 which is connected to an enclosed channel 106 that leads to the outlet 20.

Therefore in operation, water is pumped by the action of pump 72, from the water bottle 36, via conduits 64 and 68, to the steamer 88, via conduit 86. The water in conduit 86 is devoid of air bubbles, since the de-airing device 76 causes the air/water mixture to return to the water bottle 36, via conduits 80 and 82. Water in the steamer 88 is heated to produce steam which flows into the conduit 94 and then to the v-shaped junction 62, via valve 96. The cleaning agent is pumped by the action of pump 56 from the cleaning agent bottle 34, via conduits 48 and 52, to the junction 62.

Thus the steam and the cleaning agent can be mixed at the junction 62 to then simultaneously flow into the hose 18 through outlet 20, via the conduit 104 and channel 106.

The user may stop the steam by closing valve 96 which arrests the flow of steam into junction 62. As such, only the cleaning agent is dispensed through hose 18. Alternatively, pump 56 can be stopped hence, arresting supply of the cleaning agent to the junction 62 which provides for only steam to be dispensed through hose 18. Valve 96 can be controlled to modulate the amount of steam that is dispensed by the apparatus 10. Of course, this can also be done by controlling the pump 72. A further way of modulating steam is by controlling the pressure regulator 90. The pump 56 can be modulated to control the amount of cleaning agent that is dispensed by the apparatus 10. This can also be accomplished by controlling a valve within outlet 58.

Turning back to FIG. 1, the skilled artisan will easily appreciate that there are various ways of controlling steam and cleaning agent flow out of apparatus 10. For example, the control switch 106 on the control panel 44 can turn the apparatus 10 on and control switch 108 can activate the heating element within the steamer 88 in order to produce steam. A dial 110 can modulate the amount of steam flowing out of nozzle 24 by modulating pump 72, pressure regulator 90, valve 96 or the temperature of the heating element.

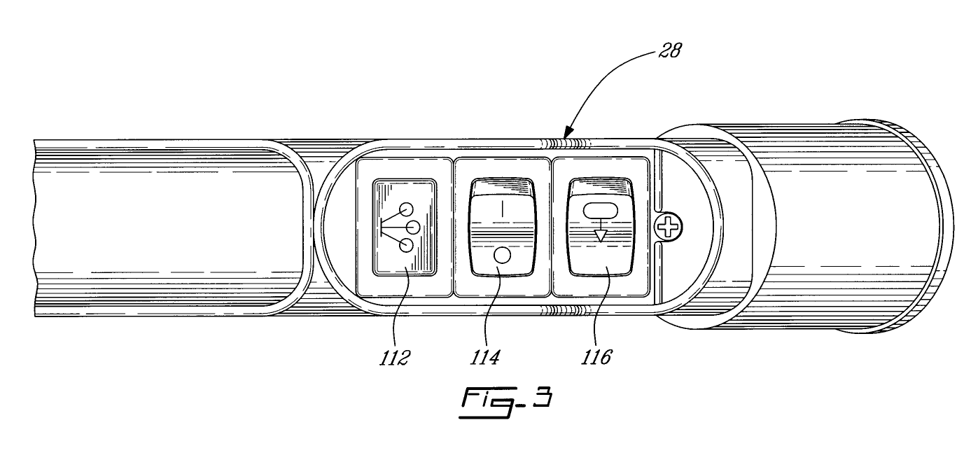

With respect to FIGS. 1 and 3, the control switch panel 28 includes a push button 112 for selectively squirting the cleaning agent out of the nozzle 24. As such, the push button 112 activates the pump 56. The switch panel also includes a toggle switches 114 and 116 movable between respective “on” and “off “positions. The toggle switch 114, when switched to the “on” position, activates valve 96 so as to allow constant flow of steam to be dispensed. The toggle switch 116, when switched to the “on” position, activates valve 56 for allowing a constant flow of cleaning agent to be dispensed. When the toggle switch 116 is in the “off” position, then the user can selectively press the push button 112 for selective dispensing of the cleaning agent. Alternatively, a similar push button can be used for steam when the toggle switch 114 is in the “off” position.

In another non-illustrated embodiment, the pump 56 is linked to a timed relay switch thus allowing the pump 56 go on and off on a set interval, in order to further control the chemical usage. The timed relay switch can be pre-programmed by a controller such as a switch or dial on the apparatus for example.

As such, the apparatus 10 provides a variety of ways of modulating steam and cleaning agent. The apparatus 10 provides for balancing between the amounts of steam and cleaning agent and for dispensing the foregoing simultaneously.

Therefore, in one embodiment, the apparatus 10 produces an agent-steam combination that is dispensed from the nozzle 24 at about 300 degrees Fahrenheit, making it possible to clean gum, paint as well as other adhesive substances more efficiently and expediently.

The present process uses an effective mixture of steam and a cleaning agent to be applied on an adhesive substance as well as the brush 26 which acts directly on the substance for removal thereof.

The steam heats up the agent and releasing the steam and the agent simultaneously provides for heat as well as chemical action on the substance. The brush 26 provides for abrasive action on the substance. The result is that the adhesive substance gets broken down to such small particles that it appears to disappear.

The method is completed by rinsing off the residue.

The cleaning agent can be selected from a variety of suitable chemical agent, detergents, and solvents as will be readily understood by the skilled artisan.

The present apparatus and method provide numerous advantages some of which are enumerated below:
There is greater control on the amount of steam and the cleaning agent.
A pure chemical agent can be used without being diluted.
The cleaning agent is not pre-heated and a system with two reservoirs provides a greater control of the temperature of the cleaning agent being applied on the targeted surface.
The use of two reservoirs provides for a smaller more efficient unit; since the reservoirs are bottles placed outside the apparatus 10, they can be easily replaced.
The concentration of the cleaning agent can remain constant, if it so desired.
The system provides for using both miscible and non-miscible chemical agents.

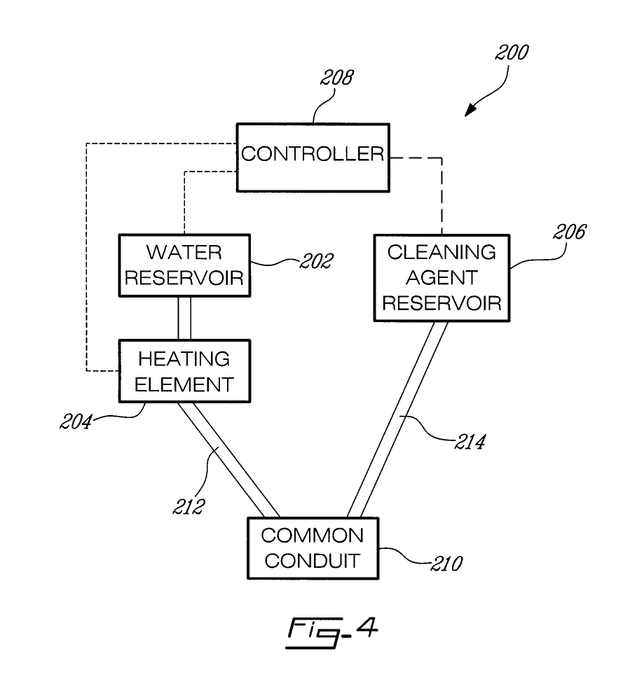

As the skilled artisan will readily appreciate, there are a variety of ways of constructing an apparatus within the scope of the present invention, as such the basic elements of such an apparatus will be discussed with reference to FIG. 4 thereby generally exemplifying a plurality of other structures not specifically discussed herein.

FIG. 4 is a schematic view of an apparatus 200 for removing an adhesive substance from a surface. The apparatus 200 includes a first reservoir 202 for containing water and a heating element 204 in fluid communication with the first reservoir for producing steam. A second reservoir 206 contains a cleaning agent. A controller 208 is linked to the first and second reservoir 202 and 206 as well as to the heating element 204 for control thereof. More specifically, the controller 208 controls the flow of steam from the heating element 204 into a common conduit 210 via a conduit 212 as well as the flow of cleaning agent into the common conduit 210 via a conduit 214. The common conduit 210 includes the nozzle previously described.

The controller may include a variety of control or switch panels with various switches, buttons, knobs and dials in order to operate the various pumps and valves for modulation of the amount and of the flow of steam and cleaning agent dispensed from the common conduit. As is known in the art, these switches, buttons, knobs and dials and dials can be linked to power supplies, heating elements, valves and pumps via electrical connection such as wiring. Thus, the switches, dials, valves, pumps and conduits described above can be provided in a variety of suitable configurations within the scope of the present invention. The skilled artisan will also appreciate that the controller can also be provided in a variety of configurations in order to provide for the selective control of the dispensing of steam and the cleaning agent.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of embodiments thereof, it can be modified, without departing from the spirit, scope and nature of the subject invention.

1. An apparatus for removing an adhesive substance from a surface, said apparatus comprising:
a first reservoir for containing water so as to provide steam;
a second reservoir for containing a cleaning agent;
a common conduit in fluid communication with said first and second reservoirs and comprising an outlet;
a controller for modulating the steam and cleaning agent that flows into said common conduit thereby selectively providing a mixture thereof for being simultaneously dispensed from said outlet;
wherein applying an effective mixture of the steam and cleaning agent onto the surface removes the adhesive substance therefrom.

2. An apparatus according to claim 1, wherein the adhesive substance is selected from the group consisting of gum, paint and a combination thereof.

3. An apparatus according to claim 1, further comprising a heating element for heating the water so as to produce steam.

4. An apparatus according to claim 3, wherein said heating element is linked to said controller for control thereof.

5. An apparatus according to claim 1, further comprising a steamer being in fluid communication with said first reservoir via a conduit.

6. An apparatus according to claim 5, further comprising a pump for providing water flow said first reservoir to said steamer.

7. An apparatus according to claim 6, wherein said pump is linked to said controller for control thereof, thereby modulating the amount of water sent to said steamer.

8. An apparatus according to claim 5, further comprising a valve interposed between said first reservoir and said steamer.

9. An apparatus according to claim 8, wherein said valve is is linked to said controller for control thereof, thereby modulating the amount of water sent to said steamer.

10. An apparatus according to claim 5, wherein said steamer comprises a heating element.

11. An apparatus according to claim 10, wherein said heating element is linked to said controller for control thereof, thereby modulating the steam produced.

12. An apparatus according to claim 5, wherein a pressure regulator is mounted to said steamer.

13. An apparatus according to claim 12, wherein said pressure regulator is linked to said controller for control thereof.

14. An apparatus according to claim 5, wherein said steamer is in fluid communication with said common conduit.

15. An apparatus according to claim 14, wherein a valve is interposed between said steamer and said common conduit.

16. An apparatus according to claim 15 said valve is linked to said controller for control thereof, thereby modulating the flow of steam entering said common conduit.

17. An apparatus according to claim 1, further comprising a pump for pumping the cleaning agent from said second reservoir to said common conduit.

18. An apparatus according to claim 17, wherein said pump is linked to said controller for control thereof, thereby modulating the flow of cleaning agent entering said common conduit.

19. An apparatus according claim 17, further comprising a valve interposed between said second reservoir and said common conduit.

20. An apparatus according to claim 19, wherein said valve is linked to said controller for control thereof, thereby modulating the flow of cleaning agent entering said common conduit.

21. An apparatus according to claim 1, further comprising a main body, said first and second reservoirs being mounted to said main body.

22. An apparatus according to claim 21, wherein said controller comprises control panel mounted to said main body

23. An apparatus according to claim 21, wherein said main body comprises a trolley.

24. An apparatus according to claim 1, wherein said common conduit comprises a hose.

25. An apparatus according to claim 1, further comprising a lance, said common conduit being mounted to said lance.

26. An apparatus according to claim 24, wherein said controller comprises switch buttons mounted to said lance.

27. An apparatus according to claim 1, wherein said outlet comprises a nozzle.

28. An apparatus according to claim 27, wherein said nozzle comprises a brush.

29. An apparatus according to claim 1, wherein the cleaning agent is selected from the group consisting of a solvent, a detergent, an adhesive removing chemical and any combination thereof.

30. A method of removing an adhesive substance from a surface, said method comprising:
providing a reservoir containing water;
heating the water so as to produce steam;
providing a reservoir containing a cleaning agent, providing for the cleaning agent and the steam to flow into a common conduit having an outlet;
selectively modulating the amount of steam and cleaning agent simultaneously flowing into the common conduit so as to provide an effective mixture; and
applying the effective mixture on the surface via the outlet so as to remove the adhesive substance therefom.
